(19) United States
(12) Patent Application Publication
(10) Pub. No.: US 2026/0044642 A1
(43) Pub. Date: Feb. 12, 2026

(54) PRINTED OBJECTS USING IMAGE CAPTURE AND BIOMIMICRY

(71) Applicant: INTERNATIONAL BUSINESS MACHINES CORPORATION, Armonk, NY (US)

(72) Inventors: Jeremy Ray Fox, Georgetown, TX (US); Martin G. Keen, Cary, NC (US); Alexander Reznicek, Troy, NY (US); Bahman Hekmatshoartabari, White Plains, NY (US)

(21) Appl. No.: 18/798,348

(22) Filed: Aug. 8, 2024

(51) Int. Cl. G06F 30/20; B29C 64/386; B33Y 70/00; G06F 113/10

(52) U.S. Cl. CPC G06F 30/20; B29C 64/386; B33Y 70/00; G06F 2113/10

(57) ABSTRACT

Methods and systems for printing an object include matching biological patterns of an original object, shown in an input image, to a database of biological information to generate an engineering parameter. A baseline design is generated using the engineering parameter derived from the input image. Performance of the baseline design is simulated according to a metric. The baseline design is iteratively adjusted to improve the simulated performance and generate a final design. A physical object is printed based on the final design.

### BACKGROUND

The present invention generally relates to three-dimensional (3D) printing and, more particularly, to creating 3D-printed objects using image capture.

3D printing takes a computer rendering of an object and translates that object into physical space by any of a variety of methods, such as by extruding a plastic material using a nozzle. Four-dimensional (4D) printing includes the creation of a 3D object that can move or change over time. 4D printing may employ intelligent materials that can change their shape, size, or other properties in response to external stimulus. However, creating a design for a 3D or 4D printed object is a labor-intensive process.

### SUMMARY

A computer-implemented method for printing an object includes matching biological patterns of an original object, shown in an input image, to a database of biological information to generate an engineering parameter. A baseline design is generated using the engineering parameter derived from the input image. Performance of the baseline design is simulated according to a metric. The baseline design is iteratively adjusted to improve the simulated performance and generate a final design. A physical object is printed based on the final design.

A computer-implemented method for printing an object includes analyzing input images to identify motion using optical flow. Biological patterns of an original object, shown in the input images, are matched to a database of biological information to generate an engineering parameter, including generating a graph that represents the original object, including nodes that represent components of the original object and edges that represent relationships between the components, and comparing the graph to graphs in the database of biological information. A baseline design is generated that replicates physical shapes identified in the original object using the engineering parameter derived from the input image, including selection of a printable material to provide motion capabilities according to the identified motion. Performance of the baseline design is simulated according to a metric. The baseline design is iteratively adjusted to improve the simulated performance and generate a final design. A physical object is printed based on the final design.

A computer program product (CPP) for printing an object includes a set of one or more computer-readable storage media and program instructions, collectively stored in the set of one or more storage media. The program instructions cause a processor set to match biological patterns of an original object, shown in an input image, to a database of biological information to generate an engineering parameter, to generate a baseline design using the engineering parameter derived from the input image, to simulate performance of the baseline design according to a metric, to iteratively adjust the baseline design to improve the simulated performance and generate a final design, and to print a physical object based on the final design.

A computer system (CS) for printing an object includes a processor set, a set of one or more computer-readable storage media, and program instructions, collectively stored in the set of one or more storage media. The program instructions cause the processor set to match biological patterns of an original object, shown in an input image, to a database of biological information to generate an engineering parameter, to generate a baseline design using the engineering parameter derived from the input image, to simulate performance of the baseline design according to a metric, to iteratively adjust the baseline design to improve the simulated performance and generate a final design, and to print a physical object based on the final design.

A CS for printing an object includes a processor set, a set of one or more computer-readable storage media, and program instructions, collectively stored in the set of one or more storage media. The program instructions cause the processor set to analyze input images to identify motion using optical flow, to match biological patterns of an original object, shown in the input images, to a database of biological information to generate an engineering parameter, including generation of a graph that represents the original object, including nodes that represent components of the original object and edges that represent relationships between the components, and comparison of the graph to graphs in the database of biological information, to generate a baseline design that replicates physical shapes identified in the original object using the engineering parameter derived from the input image, including selection of a printable material to provide motion capabilities according to the identified motion, to simulate performance of the baseline design according to a metric, to iteratively adjust the baseline design to improve the simulated performance and generate a final design, and to print a physical object based on the final design.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram illustrating a three-dimensional (3D) and four-dimensional (4D) printing process that uses biomimicry to automatically generate a design, in accordance with an embodiment of the present principles;

FIG. 2 is a block/flow diagram of a method for training and using a biological pattern matching model to replicate an object using biomimicry to identify biological principles, in accordance with an embodiment of the present invention;

FIG. 3 is a block diagram of a computing environment that performs object printing using image capture and biomimicry, in accordance with an embodiment of the present invention;

FIG. 4 is a diagram of an exemplary neural network architecture that can be used to implement part of a biological pattern matching model, in accordance with an embodiment of the present invention; and

FIG. 5 is a diagram of an exemplary deep neural network architecture that can be used to implement part of a biological pattern matching model, in accordance with an embodiment of the present invention.

### DETAILED DESCRIPTION

A design for a three-dimensional (3D) or four-dimensional (4D) printed object can be created automatically based on an input two-dimensional image or video. Using machine learning techniques, the shapes and patterns in a depicted image can be identified and movement can be analyzed. Based on the shapes, patterns, and movement, the printable parts can be automatically designed. Part of this process may include a machine learning system to identify engineering parameters for the design based on biomimicry, using known shape-changing behavior that is observed in nature to guide the construction of the object and how it changes through time.

According to an aspect of the invention, there is provided a computer-implemented method for printing an object that includes matching biological patterns of an original object, shown in an input image, to a database of biological information to generate an engineering parameter. A baseline design is generated using the engineering parameter derived from the input image.

Performance of the baseline design is simulated according to a metric. The baseline design is iteratively adjusted to improve the simulated performance and generate a final design. A physical object is printed based on the final design. Matching to biological patterns makes it possible to use biomimicry to generate a design for a 3D or 4D printed object, taking advantage of known properties of biological systems to guide the selection of engineering parameters.

In embodiments, the input image and additional images are analyzed to identify motion using optical flow. Identifying motion of the object makes it possible to create a 4D design that incorporates motion.

In embodiments, a printable material is selected to provide motion capabilities. The use of particular printable materials makes it possible to incorporate 4D features into a printed object.

In embodiments, the printable material includes at least one selected from the group of shape memory polymers, self-healing polymers, and piezoelectric materials. These printable materials represent different types of 4D printable substances, each with different properties and response to stimulus.

In embodiments, multiple printable materials are selected and each printable material is deposited during printing using a different respective print head. The use of multiple different respective print heads for the different printable materials gives good control over the deposition of each.

In embodiments, the baseline design replicates physical shapes identified in the original object. These shapes provide the basis for the 3D print, where the addition of motion turns the shapes into a 4D design.

In embodiments, adjusting the baseline design includes altering a physical shape of the baseline design. The iterative adjustment process tunes the baseline design to achieve superior performance.

In embodiments, adjusting the baseline design includes altering an engineering parameter of the baseline design. The engineering parameters may be inspired by biomimicry and may then be refined to achieve superior performance.

In embodiments, matching the biological patterns of the original object includes generating a graph that represents the original object, including nodes that represent components of the original object and edges that represent relationships between the components, and comparing the graph to graphs in the database of biological information. The use of a graph representation makes it possible to use a graph convolutional network to automatically match the object to known biological systems for biomimicry.

In embodiments, the physical object is a four-dimensional physical object that replicates motion of the original object. The introduction of motion can create a 4D physical object based on observed motion in an original object.

According to an aspect of the invention, a computer-implemented method for printing an object includes analyzing input images to identify motion using optical flow. Biological patterns of an original object, shown in the input images, are matched to a database of biological information to generate an engineering parameter, including generating a graph that represents the original object, including nodes that represent components of the original object and edges that represent relationships between the components, and comparing the graph to graphs in the database of biological information. A baseline design is generated that replicates physical shapes identified in the original object using the engineering parameter derived from the input image, including selection of a printable material to provide motion capabilities according to the identified motion.

Performance of the baseline design is simulated according to a metric. The baseline design is iteratively adjusted to improve the simulated performance and generate a final design. A physical object is printed based on the final design. Matching to biological patterns makes it possible to use biomimicry to generate a design for a 3D or 4D printed object, taking advantage of known properties of biological systems to guide the selection of engineering parameters.

According to an aspect of the invention, a computer program product (CPP) for printing an object includes a set of one or more computer-readable storage media and program instructions, collectively stored in the set of one or more storage media. The program instructions cause a processor set to match biological patterns of an original object, shown in an input image, to a database of biological information to generate an engineering parameter, to generate a baseline design using the engineering parameter derived from the input image, to simulate performance of the baseline design according to a metric, to iteratively adjust the baseline design to improve the simulated performance and generate a final design, and to print a physical object based on the final design. Matching to biological patterns makes it possible to use biomimicry to generate a design for a 3D or 4D printed object, taking advantage of known properties of biological systems to guide the selection of engineering parameters.

According to an aspect of the invention, a computer system (CS) for printing an object includes a processor set, a set of one or more computer-readable storage media, and program instructions, collectively stored in the set of one or more storage media. The program instructions cause the processor set to match biological patterns of an original object, shown in an input image, to a database of biological information to generate an engineering parameter, to generate a baseline design using the engineering parameter derived from the input image, to simulate performance of the baseline design according to a metric, to iteratively adjust the baseline design to improve the simulated performance and generate a final design, and to print a physical object based on the final design. Matching to biological patterns makes it possible to use biomimicry to generate a design for a 3D or 4D printed object, taking advantage of known properties of biological systems to guide the selection of engineering parameters.

According to an aspect of the invention, a CS for printing an object includes a processor set, a set of one or more computer-readable storage media, and program instructions, collectively stored in the set of one or more storage media. The program instructions cause the processor set to analyze input images to identify motion using optical flow, to match biological patterns of an original object, shown in the input images, to a database of biological information to generate an engineering parameter, including generation of a graph that represents the original object, including nodes that represent components of the original object and edges that represent relationships between the components, and comparison of the graph to graphs in the database of biological information, to generate a baseline design that replicates physical shapes identified in the original object using the engineering parameter derived from the input image, including selection of a printable material to provide motion capabilities according to the identified motion, to simulate performance of the baseline design according to a metric, to iteratively adjust the baseline design to improve the simulated performance and generate a final design, and to print a physical object based on the final design. Matching to biological patterns makes it possible to use biomimicry to generate a design for a 3D or 4D printed object, taking advantage of known properties of biological systems to guide the selection of engineering parameters.

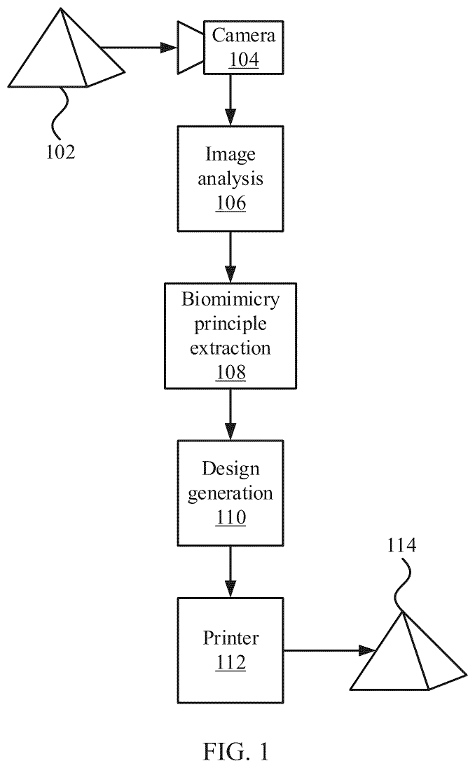

Referring now to FIG. 1, a workflow for the creation of 4D printed objects using biomimicry is shown. An image or video of original object 102 is captured using a camera 104. The original object 102 may be any static or dynamic object and may be man-made or natural. For example, the original object 102 may be a mechanical device or a living creature. The images generated by the camera 104 may be in any appropriate image or video format, for example using a 4K-resolution images over a predetermined period of time. In one specific example, the camera 104 may capture time-lapse images of a bone as it heals, capturing a frame every minute for 72 hours. While the example of bone healing is used herein to illustrate the use of biomimicry in generating a design, other applications are contemplated, such as designing bridges and high-rise buildings.

Image analysis 106 is performed on the images generated by the camera 104. This image analysis may make use of machine learning techniques to perform shape and pattern recognition and may further use optical flow analysis to analyze movement across frames. In this manner, the images of the original object 102 may be split into constituent parts. In one specific example, the image analysis 106 may make use of a convolutional neural network for feature extraction, pre-trained on a bone microscopy dataset and fine-tuned on project-specific data to identify features of the original object 102 as the bone heals. Feature extraction in this example may include, for example, calcium deposition patterns, collagen fiber orientation, and osteoblast and osteoclast activity zones. The image analysis 106 in this example may output a 2048-dimensional feature vector for each frame that represents the state of the healing process. Motion analysis may apply a dense optical flow to track cell movement and material deposition over time. Object decomposition may identify different stages of bone healing, including inflammation, soft callus formation, hard callus formation, and bone remodeling, using a U-Net architecture for semantic segmentation.

Biomimicry principle extraction 108 makes use of a database that stores information on biological structures and mechanisms. Pattern matching identifies correspondences between the parts of the original object 102 and biological counterparts in the database. Construction and movement principles may then be formulated for the original object 102 based on the biological correspondences and engineering parameters for a printing process may be extracted. In a specific example, the database may include detailed information on bone healing mechanisms, including cellular activities, protein expressions, and mineral deposition patterns. The pattern matching may use, e.g., a graph convolutional network with three graph convolutional layers, global average pooling, and two fully connected layers, trained on a dataset of bone healing sequences, to identify key stages and transitions in the healing process.

The biomimicry principle extraction may then learn association rules, for example identifying correspondences between the identified state of the healing process (e.g., “high osteoblast activity”) and other information (e.g., “increased calcium deposition”). To translate the biological processes to engineering parameters, predetermined rules may be used to guide how the design is generated. For example, osteoblast activity may be used to set a rate of material deposition in a self-healing mechanism. Collagen fiber alignment may be used to orient the shape memory polymer chains. Mineral crystal size may be used to set a particle size of a composite material.

For example, pattern matching using a graph convolutional network can be trained on a dataset of biological structures and mechanisms derived from peer-reviewed scientific literature, biological databases, and proprietary datasets. This training data may be expressed as graph representations of biological systems, where nodes biological components (e.g., cells, tissues, proteins) and edges represent interactions or relationships between these components. Each graph may be labeled with corresponding biological principles and engineering parameters, so that when an observed system is similar to a particular graph, the associated principles and parameters may be applied to improve that system.

Thus principle abstraction uses association rule learning to identify frequent patterns and correlations within the biological data. For example, principle abstraction might discover that high osteoblast activity frequently co-occurs with increased calcium deposition, which establishes a probabilistic relationship. Biometric translation then uses a knowledge base and expert system to interpret these associations in the context of broader biological processes. The expert system maps biological principles to relevant engineering parameters. For example, the rate of osteoblast activity may be translated into a parameter that controls the rate of material deposition in a self-healing system.

Design generation 110 creates a 3D model that incorporates the identified parts of the original object 102. The design generation 110 uses the engineering parameters devised by the biomimicry principle extraction 108 to incorporate shape-changing elements and to define how the object changes shape over time. Thus, starting from the shapes that are identified in image analysis 106, a baseline design can be created that replicates those shapes. Parameters of the baseline design can be controlled using the engineering parameters identified in biomimicry principle extraction 108, for example setting limits on material dimensions, properties, and interrelationships.

The design generation 110 may include a physics simulator to model behavior of the 4D design, with the simulated object being evaluated against predetermined performance criteria using a metric. In some cases a genetic algorithm optimizer may be used to refine the design to improve its performance in the simulation. The genetic algorithm optimizer may modify the structure of the design, for example by changing the dimensions and types of materials being used, and may further modify other parameters of the design, for example by changing relationships between structures and their properties. The genetic algorithm optimizer may iteratively make modifications to the baseline design to determine whether particular modifications improve or diminish the performance. Subsequent iterations may include further modifications based on previously modified designs that performed well.

The design generation 110 outputs machine-readable instructions for a 4D printer 112. The 4D printer 112 may use any combination of smart materials (e.g., those which change in some programmable way responsive to external stimuli) and conventional materials (e.g., those which do not) to create the 4D printed object 114. The printer 112 may make use of any appropriate printing technique, such as selective laser sintering, stereolithography, or fused deposition modeling.

Following the example described above, of recording bone growth for the original object 102, the time-lapse imagery of the bone's healing may be analyzed. Biomimicry principle extraction 108 uses the analysis to identify and translate key healing mechanisms into engineering parameters. For the 4D printer 112, a combination of shape memory polymers, self-healing polymers, and piezoelectric materials can be used to mimic the bone's adaptive and self-repairing properties. In some cases, each of the respective materials may be deposited using a different respective print head, to provide precision and control in material deposition, but it should be understood that there may be some cases where materials may be combined as a composite that is deposited using a shared print head.

For example, shape memory polymers may include polyurethane-based materials, which may have a glass transition temperature of about 35° C., high strain recovery, good biocompatibility, and are compatible with fused deposition modeling (FDM) printing. The self-healing polymers may include microcapsule-based self-healing epoxy, which repairs itself without external intervention, has a high healing efficiency, is compatible with the polyurethane-based shape memory polymers, and can be incorporated into 3D-printable resins. The piezoelectric materials may include polyvinylidene fluoride, which has a high piezoelectric coefficient, is flexible and compatible with 3D-printing processes, and is easily integrated with a shape memory polymer matrix. The design generation 110 may then use topology optimization, such as a solid isotropic material with penalization method, to design internal structure of the object with optimal stress distribution and self-healing capabilities.

Determining the movement properties of the design may include finite element analysis to simulate material response to various stress scenarios. Following the bone healing example, these scenarios may include tensile stresses up to 100 MPa, compressive stresses up to 150 MPa, and shear stresses up to 50 MPa. Adaptive meshing may be used based on stress concentration. The performance of the design may be evaluated according to, e.g., cyclic loading, impact resistance, and environmental resistance, along with a target healing efficiency measured as a ratio between the strength after healing to the strength of the original object.

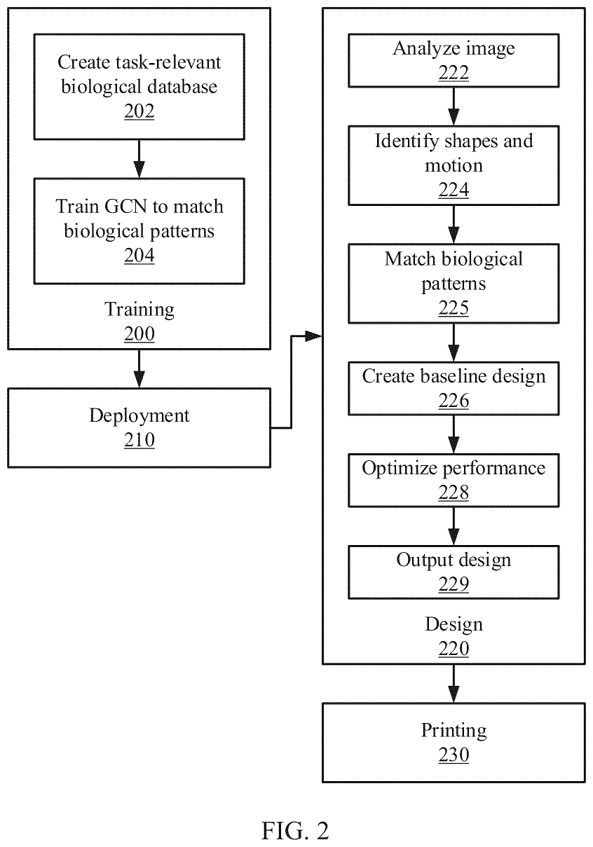

Referring now to FIG. 2, a method of training and using a biomimicry system is shown for designing printable objects. Block 200 trains the biomimicry system, which can then be deployed 210 by copying the parameters of the trained model to a target location. Block 220 creates a 3D or 4D design based on an image, using parameters set by the biomimicry system, which is then printed 230 to create the 3D or 4D object.

During training 200, a task-relevant biological database is created in block 202. This database may include information relating to a natural process or structure that is selected to be similar in function to an object that is to be copied. For example, a task of creating a flying or gliding object may use a database that includes images of wings and other aerodynamic objects. Following the example above, a task of creating a self-healing device may use a database that shows the process of bone growth and healing.

The training process for a biological pattern matching model may make use of a neural network architecture that implements a graph convolutional network. The identified structures and features identified in an image of an object may be represented as a graph, which the graph convolutional network takes as input. The output of the GCN may be expressed as a vector of probabilities, each relating to a likelihood of a match to a known biological pattern. Training may use semi-supervised learning, with a combination of labeled and unlabeled graph data, using clustering such as a k-nearest neighbor approach to identify similar biological structures.

Once the parameters of the biological pattern matching model are trained, they may be deployed 210 to a target system by copying the parameters, as well as copying the database or otherwise providing access to the database. It should be understood that the deployment 210 is intended to reflect the possibility of performing the training 200 and the design 220 at different locations and by different parties, but in some embodiments the deployment 210 may be omitted and the design 220 may be performed at the same place, and by the same party, as the training 200.

The design 220 may include analyzing 222 a captured image of an original object 102. The original object 102 may be any appropriate structure, whether natural or man-made. The analysis 222 for example using shape and pattern recognition. Block 224 identifies component shapes of the original object 102 as shown in the image, and may make use of multiple images in a video to further capture motion information. Block 225 matches biological patterns from the original object 102 against the database to set engineering parameters for the design. The matching 225 may include creating a graph to represent shapes and relationships from the image. The graph may be used to find biological patterns in the database and, based on any matches, to extract biological principles and engineering parameters that are associated with the matched pattern(s).

Based on the identified shapes and motion information, block 226 creates a baseline design that attempts to replicate the 3D or 4D shape of the original object 102 with engineering parameters set by the biological pattern matching 225. Block 228 then optimizes the performance of the baseline design, for example by simulating performance of the baseline design according to one or more metrics and making iterative changed using a genetic algorithm. Optimizing the performance may include changing the physical shape of the design and/or changing one or more engineering parameters. Block 229 then outputs a final design for a 3D or 4D printer, which block 230 uses to print the printed object 114.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

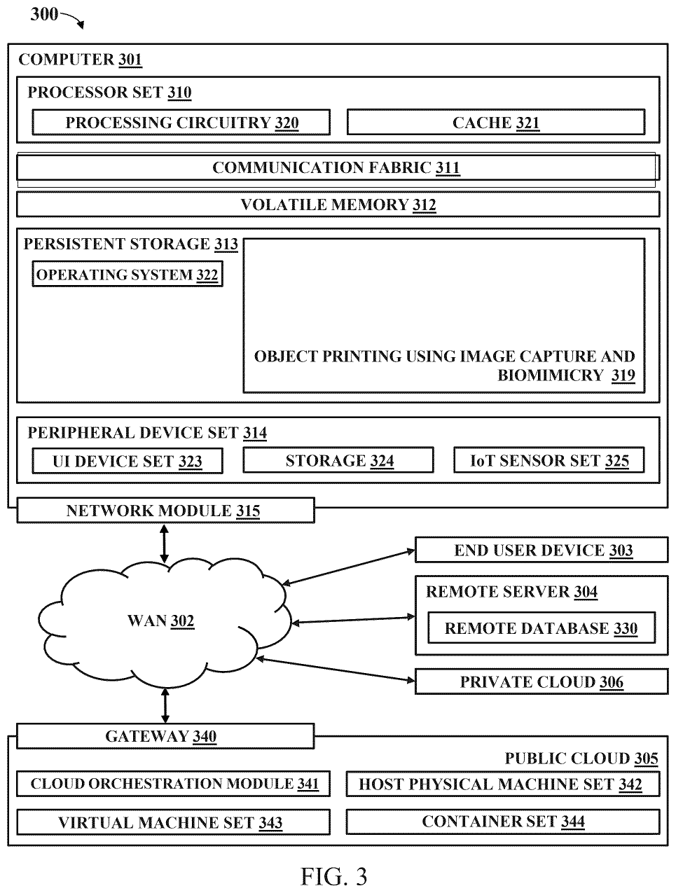

Referring now to FIG. 3, an exemplary computing environment 300 is shown. Computing environment 300 contains an example of an environment for the execution of at least some of the computer code involved in performing the inventive methods, such as object printing using image capture and biomimicry 319. In addition to block 319, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 319, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip. ” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 319 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 319 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315. WAN 302 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

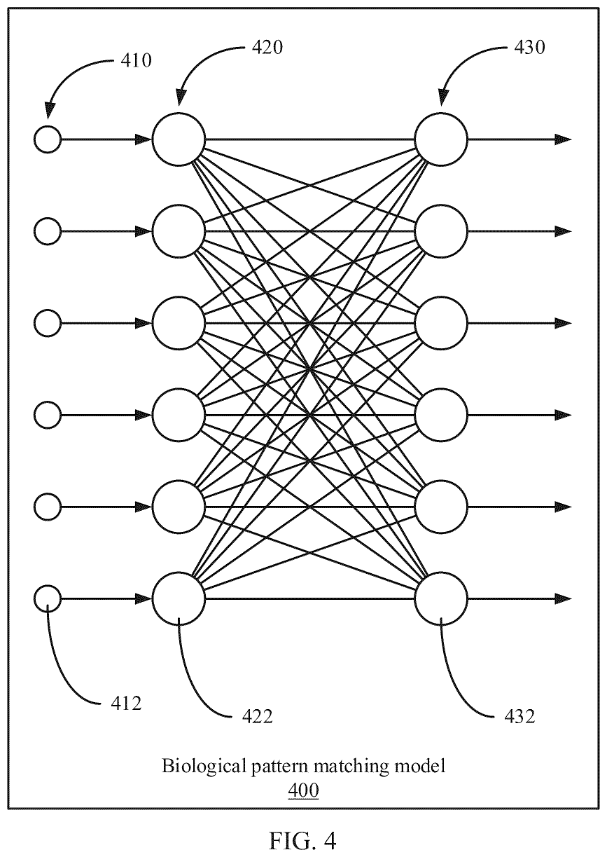

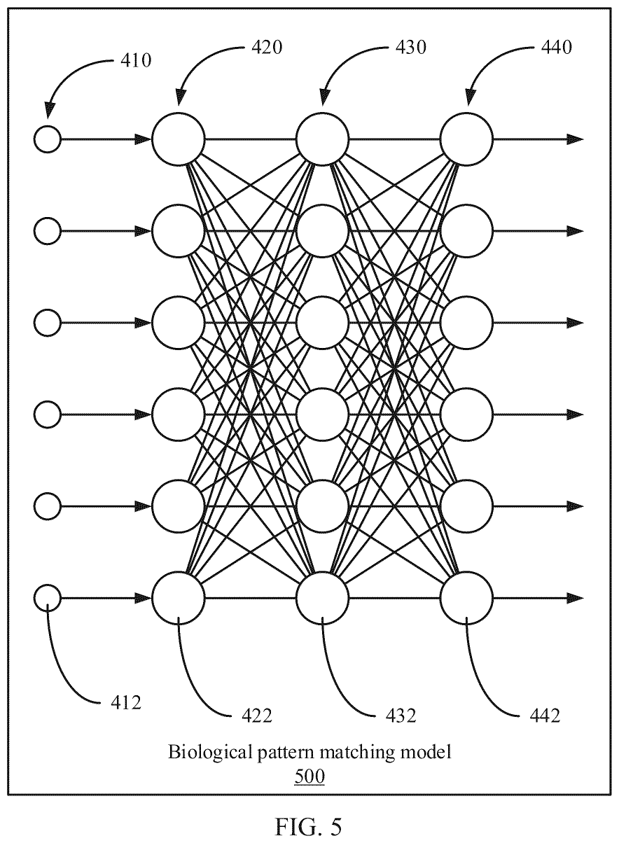

Referring now to FIGS. 4 and 5, exemplary neural network architectures are shown, which may be used to implement parts of the present models, such as discriminant models 400/1000. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 420 of source nodes 422, and a single computation layer 430 having one or more computation nodes 432 that also act as output nodes, where there is a single computation node 432 for each possible category into which the input example could be classified. An input layer 420 can have a number of source nodes 422 equal to the number of data values 412 in the input data 410. The data values 412 in the input data 410 can be represented as a column vector. Each computation node 432 in the computation layer 430 generates a linear combination of weighted values from the input data 410 fed into input nodes 420, and applies a non-linear activation function that is differentiable to the sum. The exemplary simple neural network can perform classification on linearly separable examples (e.g., patterns).

A deep neural network, such as a multilayer perceptron, can have an input layer 420 of source nodes 422, one or more computation layer(s) 430 having one or more computation nodes 432, and an output layer 440, where there is a single output node 442 for each possible category into which the input example could be classified. An input layer 420 can have a number of source nodes 422 equal to the number of data values 412 in the input data 410. The computation nodes 432 in the computation layer(s) 430 can also be referred to as hidden layers, because they are between the source nodes 422 and output node(s) 442 and are not directly observed. Each node 432, 442 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for printing an object, comprising:
matching biological patterns of an original object, shown in an input image, to a database of biological information to generate an engineering parameter;
generating a baseline design using the engineering parameter derived from the input image;
simulating performance of the baseline design according to a metric;
iteratively adjusting the baseline design to improve the simulated performance and generate a final design; and
printing a physical object based on the final design.

2. The method of claim 1, further comprising analyzing the input image and additional images to identify motion using optical flow.

3. The method of claim 2, wherein generating the baseline design includes selecting a printable material to provide motion capabilities.

4. The method of claim 3, wherein the printable material includes at least one selected from the group consisting of shape memory polymers, self-healing polymers, and piezoelectric materials.

5. The method of claim 3, wherein multiple printable materials are selected and wherein each printable material is deposited during printing using a different respective print head.

6. The method of claim 1, wherein the baseline design replicates physical shapes identified in the original object.

7. The method of claim 6, wherein adjusting the baseline design includes altering a physical shape of the baseline design.

8. The method of claim 1, wherein adjusting the baseline design includes altering an engineering parameter of the baseline design.

9. The method of claim 1, wherein matching the biological patterns of the original object includes generating a graph that represents the original object, including nodes that represent components of the original object and edges that represent relationships between the components, and comparing the graph to graphs in the database of biological information.

10. The method of claim 1, wherein the physical object is a four-dimensional physical object that replicates motion of the original object.

11. A computer-implemented method for printing an object, comprising:
analyzing input images to identify motion using optical flow;
matching biological patterns of an original object, shown in the input images, to a database of biological information to generate an engineering parameter, including generating a graph that represents the original object, including nodes that represent components of the original object and edges that represent relationships between the components, and comparing the graph to graphs in the database of biological information;
generating a baseline design that replicates physical shapes identified in the original object using the engineering parameter derived from the input image, including selection of a printable material to provide motion capabilities according to the identified motion;
simulating performance of the baseline design according to a metric;
iteratively adjusting the baseline design to improve the simulated performance and generate a final design; and
printing a physical object based on the final design.

12. The method of claim 11, wherein the printable material includes at least one selected from the group consisting of shape memory polymers, self-healing polymers, and piezoelectric materials.

13. The method of claim 11, wherein multiple printable materials are selected and wherein each printable material is deposited during printing using a different respective print head.

14. A computer program product (CPP) for printing an object, the computer program product comprising:
a set of one or more computer-readable storage media; and
program instructions, collectively stored in the set of one or more storage media, for causing a processor set to perform the following computer operations:
match biological patterns of an original object, shown in an input image, to a database of biological information to generate an engineering parameter;
generate a baseline design using the engineering parameter derived from the input image;
simulate performance of the baseline design according to a metric;
iteratively adjust the baseline design to improve the simulated performance and generate a final design; and
print a physical object based on the final design.

15. A computer system (CS) for printing an object, the computer system comprising:
a processor set;
a set of one or more computer-readable storage media; and
program instructions, collectively stored in the set of one or more storage media, for causing the processor set to perform the following computer operations:
match biological patterns of an original object, shown in an input image, to a database of biological information to generate an engineering parameter;
generate a baseline design using the engineering parameter derived from the input image;
simulate performance of the baseline design according to a metric;
iteratively adjust the baseline design to improve the simulated performance and generate a final design; and
print a physical object based on the final design.

16. The system of claim 15, further comprising analyzing the input image and additional images to identify motion using optical flow.

17. The system of claim 16, wherein generating the baseline design includes selecting a printable material to provide motion capabilities.

18. The system of claim 17, wherein the printable material includes at least one selected from the group consisting of shape memory polymers, self-healing polymers, and piezoelectric materials.

19. The system of claim 17, wherein multiple printable materials are selected and wherein each printable material is deposited during printing using a different respective print head.

20. The system of claim 15, wherein the baseline design replicates physical shapes identified in the original object.

21. The system of claim 20, wherein adjusting the baseline design includes altering a physical shape of the baseline design.

22. The system of claim 15, wherein adjusting the baseline design includes altering an engineering parameter of the baseline design.

23. The system of claim 15, wherein matching the biological patterns of the original object includes generating a graph that represents the original object, including nodes that represent components of the original object and edges that represent relationships between the components, and comparing the graph to graphs in the database of biological information.

24. A computer system (CS) for printing an object, the computer system comprising:
a processor set;
a set of one or more computer-readable storage media; and
program instructions, collectively stored in the set of one or more storage media, for causing the processor set to perform the following computer operations:
analyze input images to identify motion using optical flow;
match biological patterns of an original object, shown in the input images, to a database of biological information to generate an engineering parameter, including generating a graph that represents the original object, including nodes that represent components of the original object and edges that represent relationships between the components, and comparing the graph to graphs in the database of biological information;
generate a baseline design that replicates physical shapes identified in the original object using the engineering parameter derived from the input image, including selection of a printable material to provide motion capabilities according to the identified motion;
simulate performance of the baseline design according to a metric;
iteratively adjust the baseline design to improve the simulated performance and generate a final design; and
print a physical object based on the final design.

25. The system of claim 24, wherein the printable material includes at least one selected from the group consisting of shape memory polymers, self-healing polymers, and piezoelectric materials.
